(19) United States
(12) Patent Application Publication
(10) Pub. No.: US 2025/0303816 A1
(43) Pub. Date: Oct. 2, 2025

(54) VEHICLE THERMAL MANAGEMENT DEVICE, VEHICLE THERMAL MANAGEMENT METHOD, AND RECORDING MEDIUM

(71) Applicant: Panasonic Automotive Systems Co., Ltd., Kanagawa (JP)

(72) Inventors: Yuki IIDA, Kanagawa (JP); Toshihiro OKUDA, Tokyo (JP); Kiyokazu SHIKANO, Kanagawa (JP); Takumi MOTEKI, Kanagawa (JP); Nobumichi YASUNAMI, Kanagawa (JP)

(73) Assignee: Panasonic Automotive Systems Co., Ltd., Kanagawa (JP)

(21) Appl. No.: 19/085,667

(22) Filed: Mar. 20, 2025

(30) Foreign Application Priority Data
Mar. 29, 2024 (JP) 2024-055865

(51) Int. Cl. B60H 1/00

(52) U.S. Cl. CPC B60H 1/0073; B60H 1/00764; B60H 1/00814

(57) ABSTRACT

A vehicle thermal management device includes: a predictor that predicts, based on at least one of the vehicle information or the surroundings information that are acquired by the acquirer, a power consumption of a control unit and a heat dissipation ability of the control unit; a determiner that determines, based on the power consumption of the control unit and the heat dissipation ability of the control unit predicted by the predictor and a safety criteria parameter of the control unit, whether to optimize the power consumption of the control unit and the heat dissipation ability of the control unit, and outputs a result of determination made by the determiner; and a controller that controls the power consumption of the control unit and the heat dissipation ability of the control unit according to the result of determination made by the determiner.

### CROSS REFERENCE TO RELATED APPLICATION

The present application is based on and claims priority of Japanese Patent Application No. 2024-055865 filed on Mar. 29, 2024.

### FIELD

The present disclosure relates a vehicle thermal management device that can be mounted on a vehicle, a vehicle thermal management method, and a recording medium.

### BACKGROUND

In recent years, vehicle fuel efficiency improvement is required to achieve carbon neutrality. With currently available in-vehicle equipment mounted on a vehicle, the heat dissipation ability varies significantly according to the vehicle driving environment. For this reason, there is a need to predict an amount of heat generated by the in-vehicle equipment.

To this end, Patent Literature (PTL) 1 discloses a method and a device for performing open loop control/closed loop control on a heat flow caused due to a heat generator and a heat consumption device mounted on an automobile based on an instantaneous load state of an automobile engine, an instantaneous vehicle operation, and an ambient condition detected from mapping data.

### CITATION LIST

### Patent Literature

PTL 1: Japanese Unexamined Patent Application Publication (Translation of PCT Application) No. 2003-514184.

### SUMMARY

However, the method and the device disclosed in PTL 1 can be improved upon.

In view of the above, the present disclosure provides a vehicle thermal management device and the like capable of improving upon the above related art.

A vehicle thermal management device according to one aspect of the present disclosure includes: an acquirer that acquires vehicle information regarding a vehicle and surroundings information regarding surroundings of the vehicle; a predictor that predicts, based on at least one of the vehicle information or the surroundings information that are acquired by the acquirer, a power consumption of a control unit and a heat dissipation ability of the control unit that is provided in the vehicle; a determiner that determines, based on the power consumption of the control unit and the heat dissipation ability of the control unit predicted by the predictor and a safety criteria parameter of the control unit, whether to optimize the power consumption of the control unit and the heat dissipation ability of the control unit, and outputs a result of determination made by the determiner; and a controller that controls the power consumption of the control unit and the heat dissipation ability of the control unit according to the result of determination made by the determiner.

With the vehicle thermal management device and the like according to the one aspect of the present disclosure, it is possible to improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram of a vehicle thermal management device.

FIG. 2 is a diagram showing a relationship between (i) a scene and (ii) vehicle information and surroundings information acquired by an acquirer.

FIG. 3 is a diagram showing a data table used to perform thermal prediction.

FIG. 4 is a diagram showing a data table used to perform optimization.

FIG. 5 is a diagram showing a determination means that, after information acquisition and thermal prediction, determines whether to optimize a heat dissipation ability of a control unit and a power consumption of the control unit.

FIG. 6 is a diagram showing a power consumption, a heat dissipation ability, and a heat source temperature according to a comparative example and a power consumption, a heat dissipation ability, and a heat source temperature according to an embodiment.

FIG. 7 is a diagram showing a power consumption, a heat dissipation ability, and a heat source temperature according to Comparative Examples 1 and 2 and a power consumption, a heat dissipation ability, and a heat source temperature according to the embodiment.

FIG. 8A is a diagram showing a relationship between (i) a vehicle driving location and a driving environment and (ii) the power consumption of the control unit.

FIG. 8B is a diagram showing the vehicle information and the surroundings information.

FIG. 9 is a flowchart illustrating an example of an operation performed by the vehicle thermal management device.

### DESCRIPTION OF EMBODIMENT

Hereinafter, an embodiment will be described specifically with reference to the drawings.

The embodiment described below shows a generic or specific example of the present disclosure. The numerical values, shapes, materials, structural elements, the arrangement and connection of the structural elements, steps, the order of the steps, and the like shown in the following embodiment are merely examples, and therefore are not intended to limit the scope of the present disclosure. Also, among the structural elements described in the following embodiment, structural elements not recited in any one of the independent claims are described as arbitrary structural elements.

In addition, the diagrams are schematic representations, and thus are not necessarily true to scale. Also, in the diagrams, structural elements that are the same are given the same reference numerals.

### Embodiment

### <Configuration and Function>

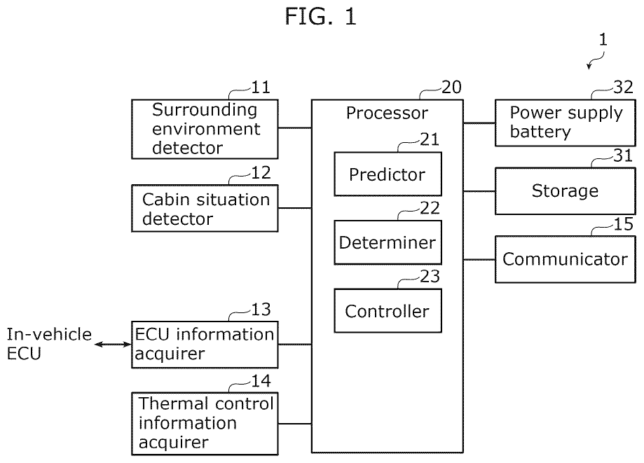

Hereinafter, a configuration of vehicle thermal management device 1, a vehicle thermal management method, and a program according to an embodiment will be described with reference to FIG. 1.

FIG. 1 is a block diagram of vehicle thermal management device 1.

As shown in FIG. 1, vehicle thermal management device 1 can optimize a power consumption of a control unit and a heat dissipation ability of the control unit that is mounted on a vehicle to achieve carbon neutrality. The control unit includes an integrated circuit and a processor that constitute an electronic control unit (ECU) and the like of the vehicle.

Specifically, vehicle thermal management device 1 includes surrounding environment detector 11, cabin situation detector 12, ECU information acquirer 13, thermal control information acquirer 14, communicator 15, processor 20, storage 31, and power supply battery 32.

Surrounding environment detector 11 is an in-vehicle camera, a temperature sensor, or the like that is provided in the vehicle, and can acquire obstacle information and environment temperature information. The obstacle information is information that indicates an object around the vehicle. Examples of the object include: a mobile object such as a pedestrian or another vehicle; and an obstacle such as an installed object. The environment temperature information is information that indicates a temperature (air temperature) around the vehicle. The obstacle information and the environment temperature information are included in surroundings information that indicates the surroundings of the vehicle. Surrounding environment detector 11 is an example of an acquirer.

Cabin situation detector 12 is an in-vehicle sensor mounted on a cabin of the vehicle, and can acquire cabin sensor information that indicates an interior of the cabin of the vehicle. The cabin sensor information includes information that indicates the number of passengers on the vehicle, and the like. The cabin sensor information is included in vehicle information regarding the vehicle. Cabin situation detector 12 is an example of an acquirer.

ECU information acquirer 13 can acquire ECU information from an in-vehicle ECU. The ECU information includes map information around the vehicle, current position information that indicates a current position of the vehicle, in-vehicle equipment information that indicates in-vehicle equipment provided in the vehicle, information that indicates an ambient temperature around the control unit, information that indicates driving control, and the like. The in-vehicle equipment includes, for example, an in-vehicle camera, an air conditioner, sound equipment, a navigation device, and the like. The ECU information is included in the vehicle information regarding the vehicle. ECU information acquirer 13 is an example of an acquirer.

Thermal control information acquirer 14 can acquire information that indicates thermal control of the control unit. The information that indicates thermal control of the control unit includes a junction temperature, a maximum surrounding temperature, an overheating protection reference value, a maximum heat transfer amount, and the like of the control unit. The information that indicates thermal control of the control unit is included in control unit information, and the control unit information is included in the vehicle information regarding the vehicle. Thermal control information acquirer 14 is an example of an acquirer.

Communicator 15 is a communication module provided in the vehicle, and can acquire environment information and vehicle driving environment information that indicates a surrounding environment in which the vehicle is traveling. The environment information is information that indicates a weather and a climate of a region in which the vehicle is present. The weather and the climate of the region in which the vehicle is present can be acquired from, for example, the automated meteorological data acquisition system (AMeDAS) of the Japan Meteorological Agency. The vehicle driving environment information is road information that is determined based on vehicle's global positioning system (GPS) information and includes a traffic congestion state of the region in which the vehicle is present, a traffic control point, the type of road, and the like. The vehicle driving environment information can be acquired in real time from, for example, a server installed in a road traffic information communication system center. The type of road includes a highway, a roadway, a tunnel, and the like. The environment information and the vehicle driving environment information are included in the surroundings information that indicates the surroundings of the vehicle. Communicator 15 is an example of an acquirer.

In the present embodiment, surrounding environment detector 11, cabin situation detector 12, ECU information acquirer 13, thermal control information acquirer 14, and communicator 15 may also be referred to collectively as the “acquirer”.

Processor 20 includes predictor 21, determiner 22, and controller 23.

Predictor 21 acquires the vehicle information and the surroundings information from the acquirer such as surrounding environment detector 11, cabin situation detector 12, ECU information acquirer 13, thermal control information acquirer 14, or communicator 15. Predictor 21 may acquire at least one of the vehicle information or the surroundings information from at least one of surrounding environment detector 11, cabin situation detector 12, ECU information acquirer 13, thermal control information acquirer 14, or communicator 15.

Predictor 21 can predict the power consumption of the control unit and the heat dissipation ability of the control unit that is provided in the vehicle based on at least one of the vehicle information or the surroundings information that are acquired by the acquirer. Predictor 21 acquires the vehicle information and the surroundings information at a predetermined time interval, and thus can predict the power consumption of the control unit and the heat dissipation ability of the control unit based on at least one of the vehicle information or the surroundings information that varies in real time.

Predictor 21 can predict the heat dissipation ability using a data table that shows a correlation between (i) the vehicle information and the surroundings information and (ii) the power consumption of the control unit and the heat dissipation ability of the control unit that correspond to the vehicle information and the surroundings information. Predictor 21 can also predict the heat dissipation ability using a learning model that has been trained to predict the power consumption of the control unit and the heat dissipation ability of the control unit from the vehicle information and the surroundings information.

For example, in the case where the vehicle is driving through a tunnel, because tunnels are dark inside, it is considered that the resolution of the in-vehicle camera decreases to increase an amount of image processing. In addition, the vehicle does not receive direct sunlight, the vehicle temperature decreases. For this reason, in the case where the surroundings information indicates that the vehicle is going to run through a tunnel, predictor 21 can predict an increase in the power consumption of the control unit and an increase in the heat dissipation ability of the control unit.

In another example, the driving speed of the vehicle decreases during traffic congestion. Accordingly, it is considered that an amount of sensing processing of a sensor provided in the vehicle decreases, and due to the vehicle driving at a low speed, the vehicle is unlikely to be cooled by air, and thus enters a second air cooling mode, resulting in a reduction in the heat dissipation ability. For this reason, for example, in the case where the surroundings information indicates that the vehicle is going into a traffic congestion, predictor 21 can predict an increase in the power consumption of the control unit and a reduction in the heat dissipation ability of the control unit.

Specific processing of predicting the heat dissipation ability, which is performed by predictor 21, will be described later.

Predictor 21 outputs, to determiner 22, the predicted power consumption of the control unit and the predicted heat dissipation ability of the control unit.

Determiner 22 can determine whether to optimize the power consumption of the control unit and the heat dissipation ability of the control unit based on the power consumption of the control unit and the heat dissipation ability of the control unit predicted by predictor 21 and a safety criteria parameter of the control unit stored in storage 31. The safety criteria parameter includes a junction temperature, a maximum surrounding temperature, an overheating protection reference value, and a maximum heat transfer amount of the control unit that satisfy safety criteria of the control unit. The junction temperature is a safety criteria parameter that requires that a heat source temperature of the control unit should not exceed a first predetermined temperature. The maximum surrounding temperature is a safety criteria parameter that requires that the surrounding temperature (ambient temperature) around the control unit should not exceed a second predetermined temperature. The overheating protection reference value is a safety criteria parameter that requires that the heat source temperature of the control unit should not continue to exceed a maximum guaranteed temperature for a continuous operating time. The maximum heat transfer amount is a safety criteria parameter that requires that the power consumption (the amount of heat transfer) of the control unit should not exceed a predetermined value.

For example, determiner 22 may determine whether to optimize the power consumption of the control unit and the heat dissipation ability of the control unit using a data table that shows a correlation between (i) the power consumption of the control unit and the heat dissipation ability of the control unit predicted by predictor 21 and (ii) the safety criteria parameter of the control unit stored in storage 31.

Also, determiner 22 may determine whether to optimize the power consumption of the control unit and the heat dissipation ability of the control unit using a learning model that has been trained to be able to determine whether to optimize the power consumption of the control unit and the heat dissipation ability of the control unit.

Specific processing of determining whether to optimize the power consumption of the control unit and the heat dissipation ability of the control unit, which is performed by determiner 22, will be described later. Determiner 22 outputs a determined result to controller 23.

Controller 23 controls the power consumption of the control unit and the heat dissipation ability of the control unit according to the result of determination made by determiner 22. Specifically, if determiner 22 determines to optimize the power consumption of the control unit and the heat dissipation ability of the control, controller 23 optimizes the power consumption of the control unit and the heat dissipation ability of the control unit. If determiner 22 determines not to optimize the power consumption of the control unit and the heat dissipation ability of the control, controller 23 maintains the power consumption of the control unit and the heat dissipation ability of the control unit at current levels.

Controller 23 can optimize the power consumption of the control unit and the heat dissipation ability of the control unit by controlling the cooling ability of at least one of a cooling fan, a water cooler, or a peltier element for cooling the control unit. Specifically, controller 23 can optimize the power consumption of the control unit and the heat dissipation ability of the control unit by adjusting a driving force (fan speed) of the cooling fan, a driving force (fan speed) of a cooling fan of a radiator included in the water cooler, a driving force (rotational speed) of a water pump, or an amount of electric current supplied to the peltier element.

Controller 23 can also feed back, to the acquirer, the power consumption of the control unit and the heat dissipation ability of the control unit when optimized and the power consumption of the control unit and the heat dissipation ability of the control unit when maintained at the current levels. That is, controller 23 can also output the current power consumption of the control unit and the current heat dissipation ability of the control unit to the acquirer (for example, thermal control information acquirer 14).

In this case, predictor 21 may acquire the current power consumption of the control unit and the current heat dissipation ability of the control unit fed back via thermal control information acquirer 14, and predict the power consumption of the control unit and the heat dissipation ability of the control unit by further taking into consideration the current power consumption of the control unit and the current heat dissipation ability of the control unit. Then, determiner 22 may again determine whether to optimize the power consumption of the control unit and the heat dissipation ability of the control unit based on the power consumption of the control unit and the heat dissipation ability of the control unit predicted by predictor 21 taking into consideration the current power consumption of the control unit and the current heat dissipation ability of the control unit, and the safety criteria parameter of the control unit stored in storage 31.

Storage 31 stores the safety criteria parameter of the control unit. Storage 31 may acquire, in time series, the vehicle information and the surroundings information acquired by the above-described acquirer. Also, storage 31 may also store a computer program executed by processor 20, and the like. Storage 31 is implemented using, for example, a semiconductor memory.

Power supply battery 32 can supply driving power to processor 20 and the above-described acquirer. Power supply battery 32 is, for example, a secondary battery, but may be a capacitor or the like.

Here, the data table used to perform thermal prediction and the data table used to perform thermal control will be described.

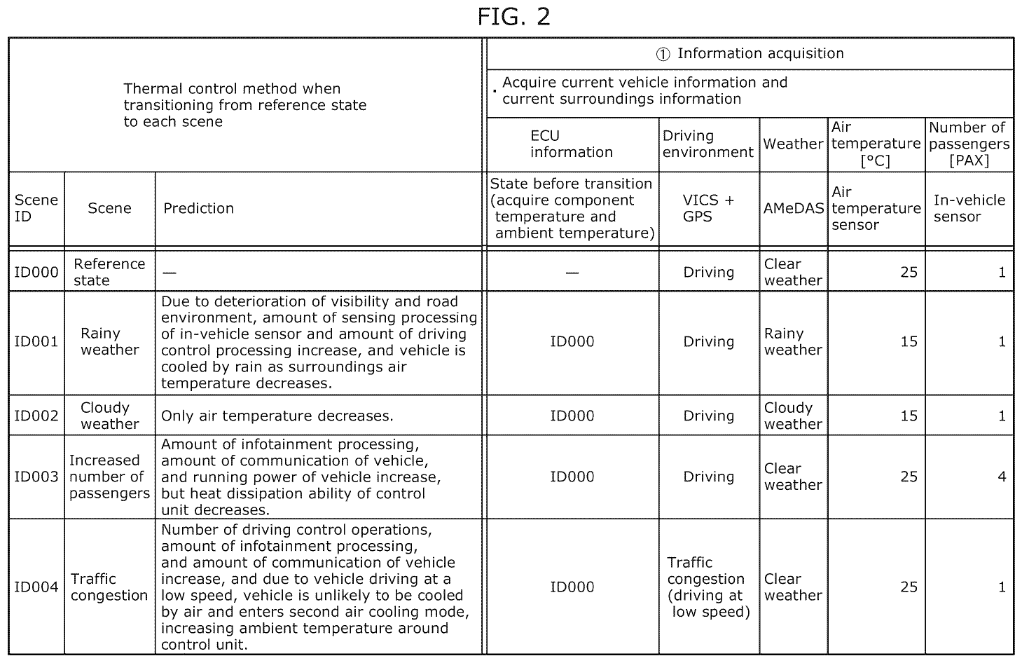

First, the vehicle information and the surroundings information acquired by the acquirer will be described with reference to FIG. 2. The following description, which will be described below with reference to FIG. 2, is merely an example, and thus the present disclosure is not limited to the description given below.

FIG. 2 is a diagram showing a relationship between (i) a scene and (ii) the vehicle information and the surroundings information acquired by the acquirer.

Each scene is set based on the vehicle information and the surroundings information, and is given an ID number.

For example, scene ID “ID000” corresponds to “reference state”, scene ID “ID001” corresponds to “rainy weather”, scene ID “ID002” corresponds to “cloudy weather”, scene ID “ID003” corresponds to “increased number of passengers”, and scene ID “ID004” corresponds to “traffic congestion”.

For example, in the case of the scene indicating “rainy weather”, it can be predicted that, due to deterioration of driver's visibility and an road environment in which the vehicle is traveling, an amount of sensing processing of the in-vehicle sensor and an amount of driving control processing increase, and the vehicle is cooled by rain as the surroundings air temperature decreases, as compared with in the case of the scene indicating “reference state”. In the case of the scene indicating “cloudy weather”, it can be predicted that the surroundings air temperature decreases as compared with in the case of the scene indicating “reference state”. In the case of the scene indicating “increased number of passengers”, it can be predicted that a period and a frequency of use of infotainment increase to increase an amount of infotainment processing, an amount of communication of the vehicle also increases, and a weight (driving power) of the vehicle as a whole increases, but the heat dissipation ability of the control unit decreases, as compared with in the case of the scene indicating “reference state”. In the case of the scene indicating “traffic congestion”, it can be predicted that the number of driving control operations such as steering, braking, and acceleration increases, and the period and the frequency of use of infotainment also increase to increase the amount of infotainment processing, and the amount of communication of the vehicle also increases, and due to the vehicle driving at a low speed, the vehicle is unlikely to be cooled by air and thus enters a second air cooling mode, resulting in an increase in the ambient temperature around the control unit.

ECU information acquirer 13 acquires the ECU information (the vehicle information) that includes the map information around the vehicle, the current position information that indicates the current position of the vehicle, the in-vehicle equipment information that indicates the in-vehicle equipment provided in the vehicle, the information that indicates the ambient temperature around the control unit, and the like. In FIG. 2, each information acquired by ECU information acquirer 13 is indicated by an ID number.

Also, communicator 15 acquires the vehicle driving environment information (the surroundings information) that includes the road information that includes the traffic congestion state of the region in which the vehicle is present, the traffic control point, the type of road, and the like. In FIG. 2, scene IDs “ID000” to “ID003” correspond to “driving” in the “driving environment” column, and scene ID “ID004” corresponds to “traffic congestion” in the “driving environment” column.

Also, communicator 15 acquires the environment information (the surroundings information) that includes the information that indicates the weather and the climate of the region in which the vehicle is present. In FIG. 2, scene IDs “ID000”, “ID003”, and “ID004” correspond to “clear weather” in the weather column and “25 [° C.]” in the air temperature column. Scene ID “ID001” corresponds to “rainy weather” in the weather column, and “15 [° C.]” in the air temperature column. Scene ID “ID002” corresponds to “cloudy weather” in the “weather” column, and “15 [° C.]” in the “air temperature” column.

Also, cabin situation detector 12 acquires the cabin sensor information (the vehicle information) that includes the information that indicates the number of passengers on the vehicle. In FIG. 2, scene IDs “ID000” to “ID002”, and “ID004” correspond to “1” in the “number of passengers” column, and scene ID “ID003” corresponds to “4” in the “number of passengers” column.

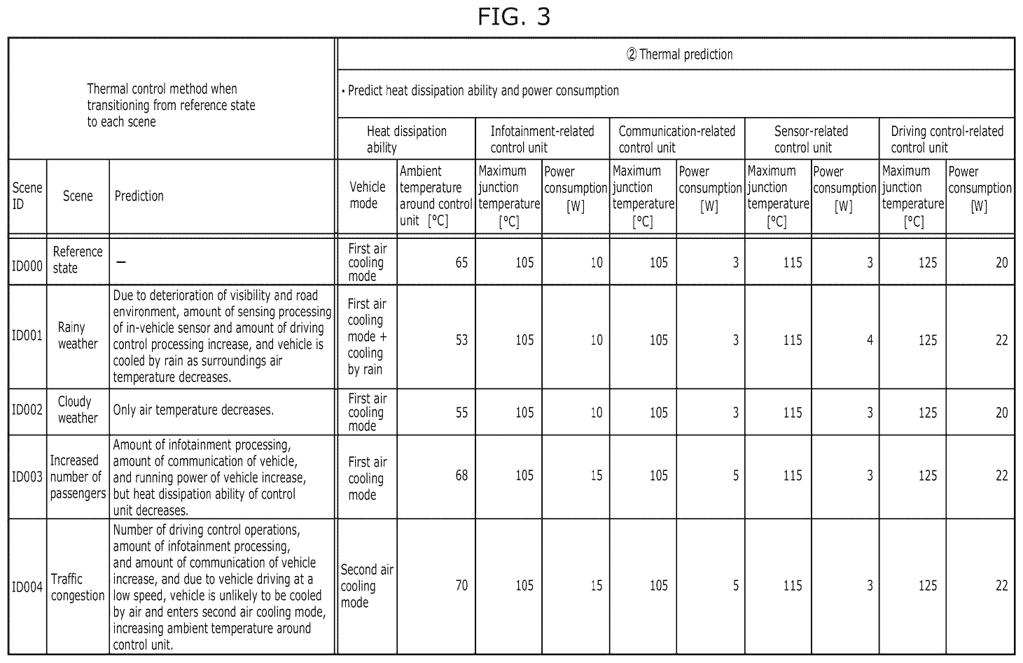

Next, thermal prediction performed by predictor 21 based on the vehicle information and the surroundings information acquired by the above-described acquirer will be described with reference to FIG. 3.

FIG. 3 is a diagram showing the data table used to perform thermal prediction.

For example, predictor 21 predicts the heat dissipation ability of the control unit. It is considered that the heat dissipation ability of the control unit is dependent on a vehicle mode and the ambient temperature around the control unit.

As used herein, the term “vehicle mode” refers to an environmental condition when heat is dissipated from the vehicle to the outside air. The driving state of the vehicle varies such as stopping, driving at a low speed, or driving at a high speed, and thus the environmental condition when heat is dissipated from the vehicle to the outside air also varies. The vehicle mode includes a first air cooling mode and a second air cooling mode. For example, when the vehicle is in a normal driving state, the vehicle mode is switched to the first air cooling mode in which, due to strong wind from the front of the vehicle, a forced convection occurs in the vehicle to dissipate heat from the vehicle to the outside air. When the vehicle stops or drives at a low speed, the vehicle mode is switched to the second air cooling mode in which, due to a rising air current caused by a natural convection, heat is dissipated from the vehicle to the outside air. When the vehicle is in a normal driving state, the heat dissipation ability is higher than that when the vehicle stops or drives at a low speed.

When heat is dissipated from the heated control unit to the vehicle in the above-described vehicle modes, the control unit is primarily “cooled with forced air” or “cooled with natural air”. The expression “cooled with forced air” refers to a state in which the control unit is cooled using at least one of a cooling fan, a water cooler, a water pump, or a peltier element. The expression “cooled with natural air” refers to a state in which the control unit is cooled naturally by the surrounding temperature, without driving a cooling fan, a water cooler, a water pump, or a peltier element.

The ambient temperature around the control unit is included in the ECU information acquired from ECU information acquirer 13.

In FIG. 3, scene IDs “ID000”, “ID002”, and “ID003” correspond to “first air cooling mode” in the “vehicle mode” column. Scene ID “ID001” corresponds to “first air cooling mode+cooling by rain” in the “vehicle mode” column. Scene ID “ID004” corresponds to “second air cooling mode” in the “vehicle mode” column. Predictor 21 predicts the ambient temperature around the control unit to be “65 [° C.]” in the case of the scene indicating “ID000”, “53 [° C.]” in the case of the scene indicating “ID001”, “55 [° C.]” in the case of the scene indicating “ID002”, “68 [° C.]” in the case of the scene indicating “ID003”, and “70 [° C.]” in the case of the scene indicating “ID004”.

In the case of the scene indicating “ID001”, the surroundings information indicates “rainy weather”. Accordingly, it is considered that the vehicle body is cooled more as compared with in the case of the scene indicating “reference state”, and thus the ambient temperature around the control unit decreases. For this reason, predictor 21 predicts the ambient temperature around the control unit to be lower than that in the case of the scene indicating “ID000” corresponding to “reference state”.

In the case of the scene indicating “ID002”, the surroundings information indicates “cloudy weather”. Accordingly, it is considered that, due to cloudy weather, the vehicle body is cooled more than in clear weather as compared with in the case of the scene indicating “reference state”, and thus the ambient temperature around the control unit decreases. For this reason, predictor 21 predicts the ambient temperature around the control unit to be lower than that in the case of the scene indicating “ID000” corresponding to “reference state” and higher than that in the case of the scene indicating “ID001”.

In the case of the scene indicating “ID003”, the vehicle information indicates “increased number of passengers”. Accordingly, it is considered that the amount of heat emitted from the passengers increases to increase the ambient temperature around the control unit, and thus the heat dissipation ability of the control unit decreases as compared with that in the case of the scene indicating “reference state”. For this reason, predictor 21 predicts the ambient temperature around the control unit to be higher than that in the case of the scene indicating “ID002”.

In the case of the scene indicating “ID004”, the surroundings information indicates “traffic congestion”. Accordingly, it is considered that the vehicle enters the second air cooling mode, and thus the heat dissipation ability of the control unit decreases as compared with that in the case of the scene indicating “reference state”. For this reason, predictor 21 predicts the ambient temperature around the control unit to be higher than that in the case of the scene indicating “ID003”.

Also, predictor 21 predicts the power consumption of an infotainment-related control unit.

In FIG. 3, predictor 21 predicts the power consumption of the infotainment-related control unit to be “10 [W]” in the case of the scenes indicating “ID000” to “ID002” and “15 [W]” in the case of the scene indicating “ID003” and “ID004”. For the infotainment-related control unit, a maximum junction temperature is set as a safety criteria parameter. The maximum junction temperature of the infotainment-related control unit is “105 [° C.]” in the case of the scenes indicating “ID000” to “ID004”.

In the case of the scene indicating “ID003”, the vehicle information indicates “increased number of passengers”. Accordingly, it is considered that the amount of infotainment processing increases to increase the power consumption of the infotainment-related control unit. For this reason, predictor 21 predicts the power consumption to be higher than that in the case of the scene indicating “ID000” corresponding to “reference state”.

In the case of the scene indicating “ID004”, the surroundings information indicates “traffic congestion”. Accordingly, it is considered that the amount of processing increases as the amount of usage of infotainment increases, which increases the power consumption of the infotainment-related control unit. For this reason, predictor 21 predicts the power consumption to be higher than that in the case of the scene indicating “ID000” corresponding to “reference state”.

Also, predictor 21 predicts the power consumption of a communication-related control unit.

In FIG. 3, scene IDs “ID000” to “ID002” correspond to “3 [W]” in the power consumption of the communication-related control unit, and scene IDs “ID003” and “ID004” correspond to “5 [W]” in the power consumption of the communication-related control unit. For the communication-related control unit, a maximum junction temperature is set as a safety criteria parameter. The maximum junction temperature of the communication-related control unit is “105 [° C.]” in the case of the scenes indicating “ID000” to “ID004”.

In the case of the scene indicating “ID003”, the vehicle information indicates “increased number of passengers”. Accordingly, it is considered that the amount of communication increases to increase the power consumption of the communication-related control unit. For this reason, predictor 21 predicts the power consumption to be higher than that in the case of the scene indicating “ID000” corresponding to “reference state”.

In the case of the scene indicating “ID004”, the surroundings information indicates “traffic congestion”. Accordingly, it is considered that the amount of usage of infotainment and telematics function used by the passengers as entertainment increases to increase the amount of communication, which increases the power consumption of the communication-related control unit. For this reason, predictor 21 predicts the power consumption to be higher than that in the case of the scene indicating “ID000” corresponding to “reference state”.

Also, predictor 21 predicts the power consumption of a sensor-related control unit.

In FIG. 3, scene IDs “ID000” and “ID002” to “ID004” correspond to “3 [W]” in the power consumption of the sensor-related control unit, and scene ID “ID001” corresponds to “4 [W]” in the power consumption of the sensor-related control unit. For the sensor-related control unit, a maximum junction temperature is set as a safety criteria parameter. The maximum junction temperature of the sensor-related control unit is “115 [° C.]” in the case of the scenes indicating “ID000” to “ID004”.

In the case of the scene indicating “ID001”, the surroundings information indicates “rainy weather”. Accordingly, it is considered that the amount of image processing of the in-vehicle camera increases to increase the power consumption of the sensor-related control unit. For this reason, predictor 21 predicts the power consumption to be higher than that in the case of the scene indicating “ID000” corresponding to “reference state”.

Also, predictor 21 predicts the power consumption of a driving control-related control unit.

In FIG. 3, scene IDs “ID000” and “ID002” correspond to “20 [W]” in the power consumption of the driving control-related control unit, and scene IDs “ID001”, “ID003”, and “ID004” correspond to “22 [W]” in the power consumption of the driving control-related control unit. For the driving control-related control unit, a maximum junction temperature is set as a safety criteria parameter. The maximum junction temperature of the driving control-related control unit is “125 [° C.]” in the case of the scenes indicating “ID000” to “ID004”.

In the case of the scene indicating “ID001”, the surroundings information indicates “rainy weather”. Accordingly, it is considered that the number of driving control operations increases to increase the power consumption of the driving control-related control unit. For this reason, predictor 21 predicts the power consumption to be higher than that in the case of the scene indicating “ID000” corresponding to “reference state”.

In the case of the scene indicating “ID003”, the vehicle information indicates “increased number of passengers”. Accordingly, it is considered that the weight of the vehicle as a whole increases, which requires the driving force of the vehicle to increase the power consumption of the driving control-related control unit. For this reason, predictor 21 predicts the power consumption to be higher than that in the case of the scene indicating “ID000” corresponding to “reference state”.

In the case of the scene indicating “ID004”, the surroundings information indicates “traffic congestion”. Accordingly, it is considered that the number of driving control operations increases to increase the power consumption of the driving control-related control unit. For this reason, predictor 21 predicts the power consumption to be higher than that in the case of the scene indicating “ID000” corresponding to “reference state”.

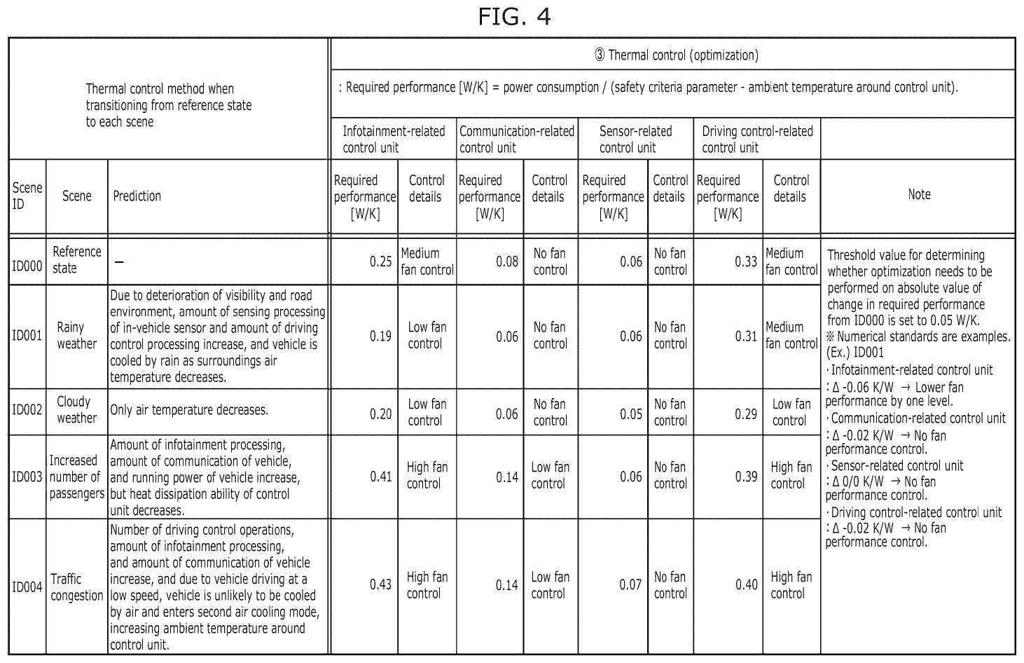

Next, an example will be described with reference to FIG. 4 in which determiner 22 determines, based on the predicted power consumption of the control unit, the predicted heat dissipation ability of the control unit, and the safety criteria parameter of the control unit, whether to optimize the power consumption of the control unit and the heat dissipation ability of the control unit, and outputs a determined result.

FIG. 4 is a diagram showing the data table used to perform optimization.

In FIG. 4, a required performance and control details are set for each of the infotainment-related control unit, the communication-related control unit, the sensor-related control unit, and the driving control-related control unit.

$$The required performance can be determined by the following \\ equation : required performance [ W / K ] = power consumption / \\ ( safety criteria parameter - ambient temperature around control unit ) .$$

The safety criteria parameter is, for example, a maximum junction temperature.

The control details indicate whether to optimize the power consumption of the control unit and the heat dissipation ability of the control unit, and also indicate what kind of operation is performed to execute the optimization. In FIG. 4, fan driving force control is indicated as high, medium, or low.

In FIG. 4, the required performance for the infotainment-related control unit is calculated to be “0.25 [W/K]” in the case of the scene indicating “ID000”. In this case, “medium fan control” is set in the “control details” column.

The required performance for the infotainment-related control unit is calculated to be “0.19 [W/K]” in the case of the scene indicating “ID001”, which is lower than that in the case of the scene indicating “ID000” corresponding to “reference state”. Accordingly, “low fan control” is set in the “control details” column.

The required performance for the infotainment-related control unit is calculated to be “0.20 [W/K]” in the case of the scene indicating “ID002”, which is lower than that in the case of the scene indicating “ID000” corresponding to “reference state”. Accordingly, “low fan control” is set in the “control details” column.

The required performance for the infotainment-related control unit is calculated to be “0.41 [W/K]” in the case of the scene indicating “ID003”, which is higher than that in the case of the scene indicating “ID000” corresponding to “reference state”. Accordingly, “high fan control” is set in the “control details” column.

The required performance for the infotainment-related control unit is calculated to be “0.43 [W/K]” in the case of the scene indicating “ID004”, which is higher than that in the case of the scene indicating “ID000” corresponding to “reference state”. Accordingly, “high fan control” is set in the “control details” column.

The required performance for the communication-related control unit is calculated to be “0.08 [W/K]” in the case of the scene indicating “ID000”. In this case, “no fan control” is set in the “control details” column.

The required performance for the communication-related control unit is calculated to be “0.06 [W/K]” in the case of the scene indicating “ID001”, which is lower than that in the case of the scene indicating “ID000” corresponding to “reference state”. Accordingly, “no fan control” is set in the “control details” column.

The required performance for the communication-related control unit is calculated to be “0.06 [W/K]” in the case of the scene indicating “ID002”, which is lower than that in the case of the scene indicating “ID000” corresponding to “reference state”. Accordingly, “no fan control” is set in the “control details” column.

The required performance for the communication-related control unit is calculated to be “0.14 [W/K]” in the case of the scene indicating “ID003”, which is higher than that in the case of the scene indicating “ID000” corresponding to “reference state”. Accordingly, “low fan control” is set in the “control details” column.

The required performance for the communication-related control unit is calculated to be “0.14 [W/K]” in the case of the scene indicating “ID004”, which is higher than that in the case of the scene indicating “ID000” corresponding to “reference state”. Accordingly, “low fan control” is set in the “control details” column.

The required performance for the sensor-related control unit is calculated to be “0.06 [W/K]” in the case of the scene indicating “ID000”. In this case, “no fan control” is set in the “control details” column.

The required performance for the sensor-related control unit is calculated to be “0.06 [W/K]” in the case of the scene indicating “ID001”, which is the same as that in the case of the scene indicating “ID000” corresponding to “reference state”. Accordingly, “no fan control” is set in the “control details” column.

The required performance for the sensor-related control unit is calculated to be “0.05 [W/K]” in the case of the scene indicating “ID002”, which is the same as that in the case of the scene indicating “ID000” corresponding to “reference state”. Accordingly, “no fan control” is set in the “control details” column.

The required performance for the sensor-related control unit is calculated to be “0.06 [W/K]” in the case of the scene indicating “ID003”, which is the same as that in the case of the scene indicating “ID000” corresponding to “reference state”. Accordingly, “no fan control” is set in the “control details” column.

The required performance for the sensor-related control unit is calculated to be “0.07 [W/K]” in the case of the scene indicating “ID004”, which is the same as that in the case of the scene indicating “ID000” corresponding to “reference state”. Accordingly, “no fan control” is set in the “control details” column.

The required performance for the driving control-related control unit is calculated to be “0.33 [W/K]” in the case of the scene indicating “ID000”. In this case, “medium fan control” is set in the “control details” column.

The required performance for the driving control-related control unit is calculated to be “0.31 [W/K]” in the case of the scene indicating “ID001”, which is lower than that in the case of the scene indicating “ID000” corresponding to “reference state”. Accordingly, “medium fan control” is set in the “control details” column.

The required performance for the driving control-related control unit is calculated to be “0.29 [W/K]” in the case of the scene indicating “ID002”, which is lower than that in the case of the scene indicating “ID000” corresponding to “reference state”. Accordingly, “low fan control” is set in the “control details” column.

The required performance for the driving control-related control unit is calculated to be “0.39 [W/K]” in the case of the scene indicating “ID003”, which is higher than that in the case of the scene indicating “ID000” corresponding to “reference state”. Accordingly, “high fan control” is set in the “control details” column.

The required performance for the driving control-related control unit is calculated to be “0.40 [W/K]” in the case of the scene indicating “ID004”, which is higher than that in the case of the scene indicating “ID000” corresponding to “reference state”. Accordingly, “high fan control” is set in the “control details” column.

In the description given above, “no fan control” corresponds to “cooled with natural air”, and “low fan control”, “medium fan control”, and “high fan control” correspond to “cooled with forced air”.

Here, scene ID “ID001” with respect to scene ID “ID000” corresponding to “reference state” will be described with reference to FIG. 4.

The required performance for the infotainment-related control unit is lower in scene ID “ID001” than in scene ID “ID000” by 0.06 W/K. In the case where a determination threshold value for determining the absolute value of change in the required performance is set to 0.05 W/K, determiner 22 determines to optimize the power consumption of the control unit and the heat dissipation ability of the control. Accordingly, controller 23 lowers the cooling ability of the fan for cooling the infotainment-related control unit by one level.

The required performance for the communication-related control unit is lower in scene ID “ID001” than in scene ID “ID000” by 0.02 W/K. In the case where the determination threshold value is set to 0.05 W/K, determiner 22 determines not to optimize the power consumption of the control unit and the heat dissipation ability of the control. Accordingly, controller 23 does not change the cooling ability of the fan for cooling the communication-related control unit.

The required performance for the sensor-related control unit is the same in scene ID “ID001” and scene ID “ID000”. In the case where the determination threshold value is set to 0.05 W/K, determiner 22 determines not to optimize the power consumption of the control unit and the heat dissipation ability of the control. Accordingly, controller 23 does not change the cooling ability of the fan for cooling the sensor-related control unit.

The required performance for the driving control-related control unit is lower in scene ID “ID001” than in scene ID “ID000” by 0.02 W/K. In the case where the determination threshold value is set to 0.05 W/K, determiner 22 determines not to optimize the power consumption of the control unit and the heat dissipation ability of the control. Accordingly, controller 23 does not change the cooling ability of the fan for cooling the driving control-related control unit.

The threshold values given above are merely examples, and therefore are not limited to those of the present embodiment.

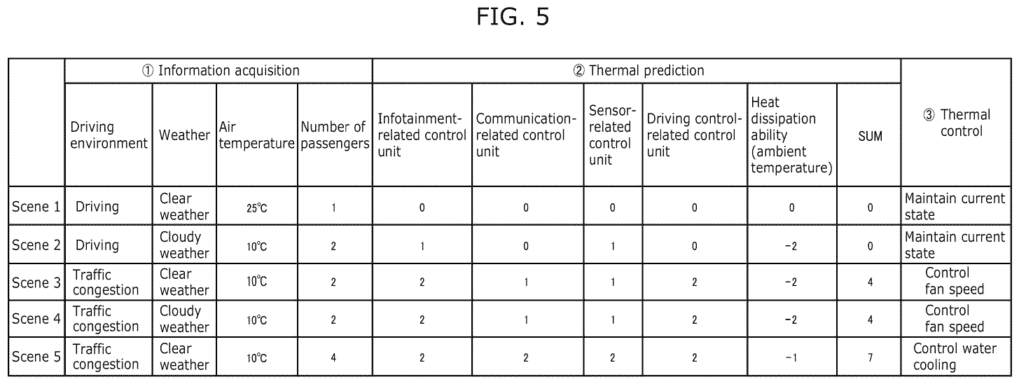

For example, a determination means that determines whether to optimize the power consumption of the infotainment-related control unit by determiner 22 will be described with reference to FIG. 5.

FIG. 5 is a diagram showing a determination means that, after information acquisition and thermal prediction, determines whether to optimize the heat dissipation ability of the control unit and the power consumption of the control unit.

FIG. 5 shows, in the “information acquisition” column, the vehicle driving environment and the weather and the ambient temperature of the region in which the vehicle is present that are included in the surroundings information acquired by the acquirer, and the number of passengers that is included in the vehicle information acquired by the acquirer. The “thermal prediction” column shows determination values of the infotainment-related control unit, the communication-related control unit, the sensor-related control unit, the driving control-related control unit, and the heat dissipation ability (the air temperature around the control unit) based on the heat dissipation ability of the control unit and the power consumption of the control unit predicted by predictor 21 and the safety criteria parameter of the control unit, used by determiner 22 when determining whether to optimize the power consumption of the control unit and the heat dissipation ability of the control unit.

For example, in scene 1, the driving environment indicates “driving”, the weather indicates “clear weather”, the air temperature indicates “25° C.”, and the number of passengers indicates “1”. In this case, all determination values of the infotainment-related control unit, the communication-related control unit, the sensor-related control unit, the driving control-related control unit, and the heat dissipation ability are set to “0”, and thus the sum total (SUM) is “0”. Accordingly, determiner 22 determines not to optimize the power consumption of the control unit and the heat dissipation ability of the control. In this case, controller 23 maintains the current state of the control unit, and does not optimize the power consumption of the control unit and the heat dissipation ability of the control unit.

Also, in scene 2, the number of passengers indicates “2”, and thus the amount of infotainment processing increases as compared with that in the case of scene 1. Also, the weather indicates “cloudy weather”, and thus the visibility decreases to increase the amount of image processing of the in-vehicle camera. Accordingly, the determination values of the infotainment-related control unit and the sensor-related control unit are set to “1”, and the determination values of the communication-related control unit and the driving control-related control unit are set to “0”. Also, the air temperature indicates “10° C.”, which is lower than that in the case of scene 1, and the vehicle is cooled. Accordingly, the determination value of the heat dissipation ability is set to “−2”. At this time, the sum total (SUM) is “0”. Accordingly, determiner 22 determines not to optimize the power consumption of the control unit and the heat dissipation ability of the control. In this case, controller 23 maintains the current state of the control unit, and does not optimize the power consumption of the control unit and the heat dissipation ability of the control unit.

Also, in scene 3, the number of passengers indicates “2”, and the driving environment indicates “traffic congestion”. Accordingly, the amount of infotainment processing increases as compared with that in the case of scene 1, and the number of driving control operations also increases. Thus, the determination values of the infotainment-related control unit and the driving control-related control unit are set to “2”. Although the weather indicates “clear weather”, the driving environment indicates “traffic congestion”, and thus the amount of usage of communication increases, and the amount of image processing of the in-vehicle camera to detect the congested surroundings also increases. Accordingly, the determination values of the communication-related control unit and the sensor-related control unit are set to “1”. Also, the air temperature indicates “10° C.”, which is lower than that in the case of scene 1, and thus the vehicle is cooled. Accordingly, the determination value of the heat dissipation ability is set to “−2”. At this time, the sum total (SUM) is “4”. Based on the above, determiner 22 determines to optimize the power consumption of the control unit and the heat dissipation ability of the control. In this case, controller 23 optimizes the power consumption of the control unit and the heat dissipation ability of the control unit by controlling the cooling ability of at least one of a cooling fan, a water cooler, a water pump, or a peltier element for cooling the control unit.

Also, in scene 4, the number of passengers indicates “2”, and the driving environment indicates “traffic congestion”. Accordingly, the amount of infotainment processing increases as compared with that in the case of scene 1, and the number of driving control operations also increases. Thus, the determination values of the infotainment-related control unit and the driving control-related control unit are set to “2”. Although the weather indicates “cloudy weather”, because the driving environment indicates “traffic congestion”, the amount of usage of communication increases, and the amount of image processing of the in-vehicle camera also increases to detect the congested surroundings. Accordingly, the determination values of the communication-related control unit and the sensor-related control unit are set to “1”. Also, the air temperature indicates “10° C.”, which is lower than that in the case of scene 1, and the vehicle is cooled. Accordingly, the determination value of the heat dissipation ability is set to “−2”. At this time, the sum total (SUM) is “4”. Based on the above, determiner 22 determines to optimize the power consumption of the control unit and the heat dissipation ability of the control. In this case, controller 23 optimizes the power consumption of the control unit and the heat dissipation ability of the control unit by controlling the cooling ability of any one of a cooling fan, a water cooler, a water pump, or a peltier element for cooling the control unit.

Also, in scene 5, the number of passengers indicates “4”, and the driving environment indicates “traffic congestion” and thus the amount of infotainment processing increases as compared with that in the case of scene 1, the amount of usage of communication increases as compared with the case of scene 3 and scene 4, and the amount of image processing of the in-vehicle camera and the amount of image processing in the cabin camera also increase to detect the congested surroundings, which increases the number of driving control operations. Accordingly, the determination values of the infotainment-related control unit, the communication-related control unit, the sensor-related control unit, and the driving control-related control unit are set to “2”. Although the weather indicates “clear weather”, because the number of passengers is greater than that in the case of scene 3 and scene 4, and the air temperature indicates “10° C.”, which is lower than that in the case of scene 1, the vehicle is cooled. Accordingly, the determination value of the heat dissipation ability is set to “−1”. At this time, the sum total (SUM) is “7”. Based on the above, determiner 22 determines to optimize the power consumption of the control unit and the heat dissipation ability of the control. In this case, controller 23 optimizes the power consumption of the control unit and the heat dissipation ability of the control unit by controlling the cooling ability of any one of a cooling fan, a water cooler, a water pump, or a peltier element for cooling the control unit.

Controller 23 feeds back, to the acquirer, the current power consumption of the control unit and the current heat dissipation ability of the control unit, irrespective of whether the current state is maintained or optimization has been performed. After that, the same processing operations as those described above are performed in predictor 21, determiner 22, and controller 23.

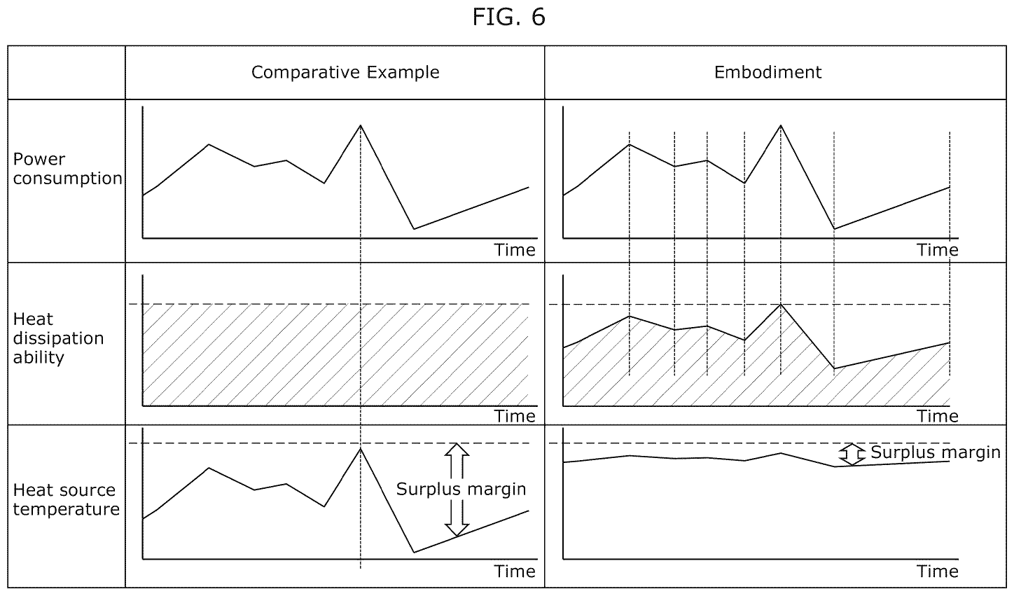

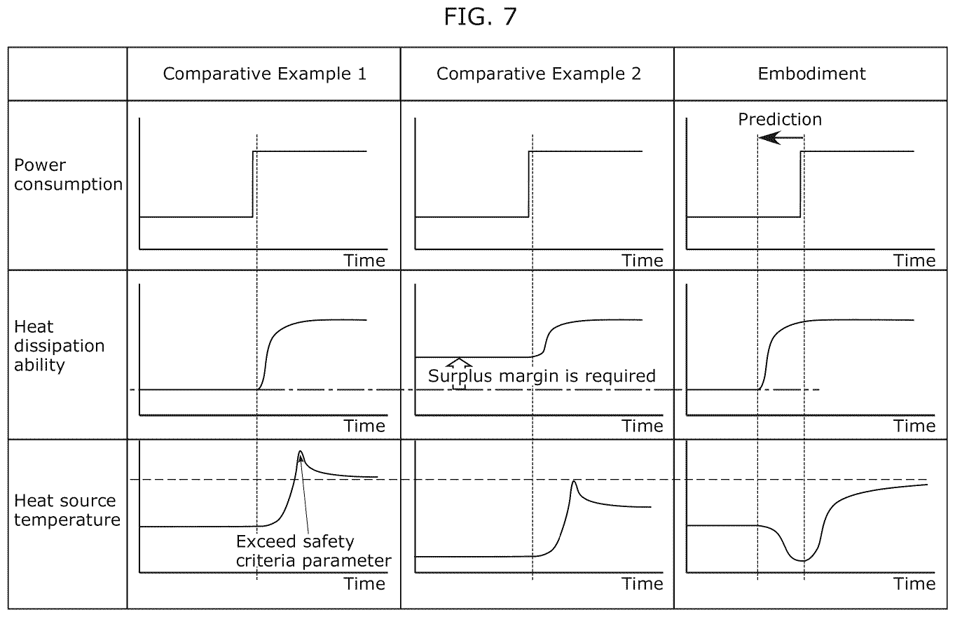

Next, differences between (i) the power consumption, the heat dissipation ability, and the heat source temperature of the control unit according to comparative examples and (ii) the power consumption, the heat dissipation ability, and the heat source temperature of the control unit according to the present embodiment will be described with reference to FIGS. 6 and 7.

FIG. 6 is a diagram showing the power consumption, the heat dissipation ability, and the heat source temperature according to a comparative example and the power consumption, the heat dissipation ability, and the heat source temperature according to the present embodiment. FIG. 7 is a diagram showing the power consumption, the heat dissipation ability, and the heat source temperature according to Comparative Examples 1 and 2 and the power consumption, the heat dissipation ability, and the heat source temperature according to the present embodiment.

For example, as shown in FIG. 6, in a comparative example that is designed to not perform thermal prediction and control, it is necessary to design the heat dissipation ability of the control unit based on the maximum power consumption in the power consumption, and the heat dissipation ability of the control unit is set to a fixed value as indicated by hatching so as to be less than or equal to a safety criteria parameter indicated by a broken line. In this case, the heat source temperature of the control unit is correlated with the power consumption, resulting in a high surplus margin, which may excessively increase the heat dissipation ability of the control unit.

However, according to the present embodiment that is designed to control the heat dissipation ability of the control unit according to the power consumption of the control unit so as to satisfy the safety criteria parameter, the heat dissipation ability of the control unit is less than the safety criteria parameter. At this time, the heat dissipation ability of the control unit is in correlation with the power consumption of the control unit. Accordingly, in the present embodiment, the surplus margin in the heat source temperature of the control unit is smaller than that of the comparative example, and thus a situation is unlikely to occur in which the heat dissipation ability of the control unit is excessively increased.

Furthermore, as shown in FIG. 7, in the case of a configuration in which the heat dissipation ability of the control unit is increased after an increase in the power consumption of the control unit is detected as in Comparative Example 1, the heat source temperature of the control unit may exceed the safety criteria parameter indicated by a broken line.

Then, a configuration as in Comparative Example 2 may be conceived in which the heat dissipation ability of the control unit is increased in advance before detection of the power consumption, and the heat dissipation ability of the control unit is increased after an increase in the power consumption of the control unit is detected. In this case, because the heat dissipation ability of the control unit is increased in advance, at least one of a cooling fan, a water cooler, a water pump, or a peltier element needs to be driven in advance. As a result, in Comparative Example 2, the surplus margin is higher than a dash-dotted line that indicates the heat dissipation ability during normal time, which results in an increase in the power consumption of the vehicle thermal management device, a reduction in the energy efficiency of the vehicle thermal management device, and an insufficient improvement of the vehicle fuel efficiency.

To address the above, in the present embodiment, predictor 21 predicts the power consumption of the control unit and the heat dissipation ability of the control unit provided in the vehicle based on at least one of the vehicle information or the surroundings information. With this configuration, a situation as in Comparative Example 1 is unlikely to occur in which the heat source temperature of the control unit exceeds the safety criteria parameter, and a situation as in Comparative Example 2 is also unlikely to occur in which the energy efficiency of the vehicle thermal management device is reduced, and the improvement of the vehicle fuel efficiency is insufficient

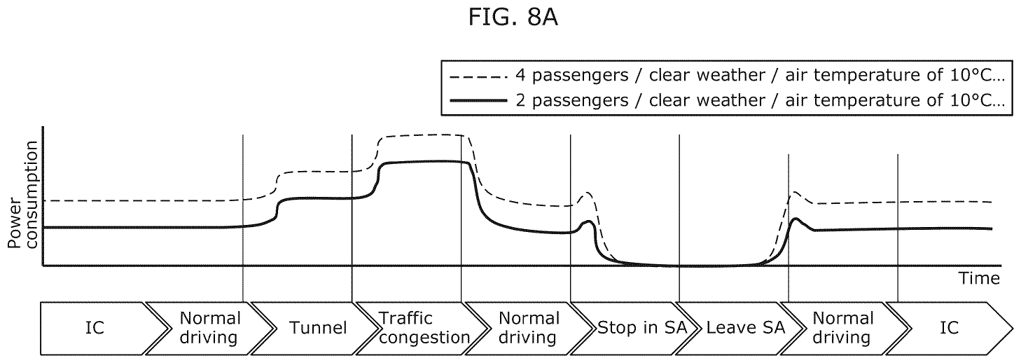

Next, the prediction of the power consumption performed when the vehicle drives on a highway will be described with reference to FIGS. 8A and 8B.

FIG. 8A is a diagram showing a relationship between (i) vehicle driving location and driving environment and (ii) the power consumption of the control unit. In FIG. 8A, a solid line indicates the case where the number of passengers is two, and a broken line indicates the case where the number of passengers is four. In FIG. 8A, the power consumption of the control unit is shown for each scene set based on the vehicle information and the surroundings information shown in FIG. 8B. FIG. 8A shows the case of scenes 1 and 3 shown in FIG. 8B in which the weather is “clear weather” and the air temperature is “10° C.”. FIG. 8B is a diagram showing a data table of the vehicle information and the surroundings information. It should be noted that scenes 1 to 4 shown in FIG. 8B are different from scenes 1 to 5 shown in FIG. 5.

First, in the case where the vehicle enters an interchange, and then drives on a highway in a normal driving state, the power consumption of the control unit is in a reference state. After that, when the vehicle enters a tunnel, the resolution of the in-vehicle camera decreases to increase the amount of image processing, resulting in an increase in the power consumption of the control unit.

Furthermore, when the vehicle is involved in a traffic congestion, the number of driving control operations increases, and the amount of infotainment processing and the amount of communication of the vehicle also increase to increase the power consumption of the control unit.

When the vehicle gets out of the traffic congestion and returns to the normal driving state, the power consumption of the control unit decreases, and the power consumption of the control unit returns to the reference state.

When the driver attempts to park the vehicle in a service area on the highway, the number of driving control operations increases, and thus the power consumption of the control unit also increases to be higher than that in the reference state. When the vehicle is parked in the service area, the power consumption of the control unit reaches 0.

After that, when the driver attempts to leave the service area, the number of driving control operations increases. Because the vehicle drives on the highway in the normal driving state immediately after the power consumption of the control unit increases to be higher than that in the reference state, the power consumption of the control unit returns to the reference state.

As described above, with vehicle thermal management device 1, the vehicle thermal management method, and the program according to the present embodiment, the power consumption of the control unit can be predicted using a data table or a learning model according to the scene in which the vehicle drives such as those shown in FIG. 8A as examples including “IC (interchange)”, “normal driving”, “tunnel”, “traffic congestion”, “stopping in SA (service area)”, and “leaving SA”.

### <Example of Operation>

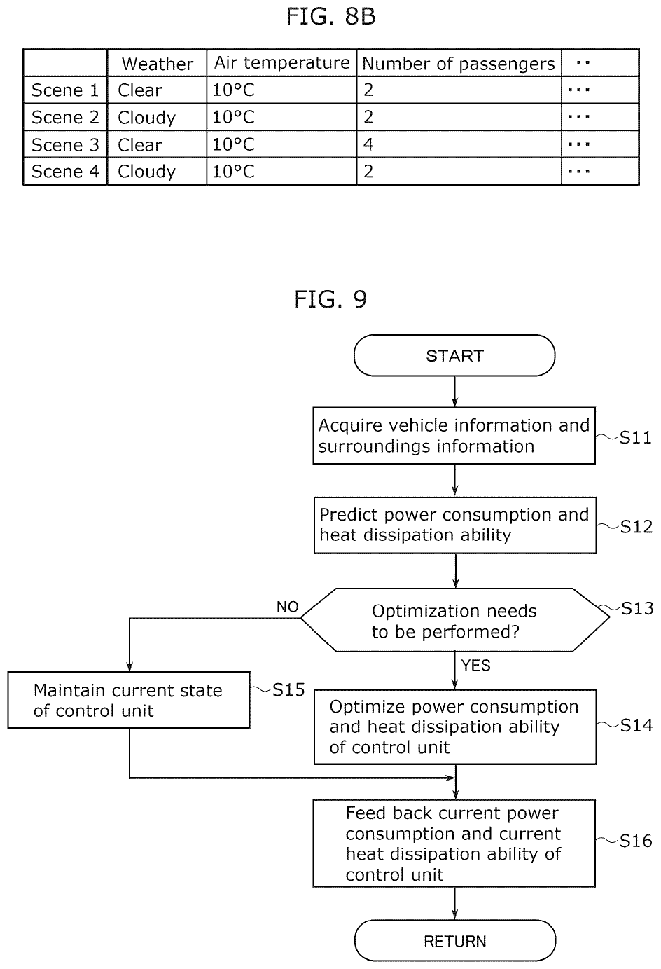

Next, an operation performed by vehicle thermal management device 1, the vehicle thermal management method, and the program according to the present embodiment will be described with reference to FIG. 9.

FIG. 9 is a flowchart illustrating an example of an operation performed by vehicle thermal management device 1.

First, the acquirer acquires the vehicle information and the surroundings information (S11). For example, surrounding environment detector 11 that is an example of an acquirer can acquire the obstacle information and the environment temperature information included in the surroundings information. Also, cabin situation detector 12 that is an example of an acquirer can acquire the cabin sensor information included in the vehicle information. Also, ECU information acquirer 13 that is an example of an acquirer can acquire the ECU information included in the vehicle information. Also, thermal control information acquirer 14 that is an example of an acquirer can acquire the control unit information included in the vehicle information. Also, communicator 15 that is an example of an acquirer can acquire the environment information and the vehicle driving environment information included in the surroundings information.

Next, predictor 21 predicts the power consumption of the control unit and the heat dissipation ability of the control unit provided in the vehicle based on at least one of the vehicle information and the surroundings information that were acquired by the acquirer (S12). At this time, predictor 21 can predict the heat dissipation ability using a data table that shows a correlation between (i) the vehicle information and the surroundings information and (ii) the power consumption of the control unit and the heat dissipation ability of the control unit, or using a learning model that has been trained to predict the power consumption of the control unit and the heat dissipation ability of the control unit based on the vehicle information and the surroundings information.

Next, determiner 22 determines whether to optimize the power consumption of the control unit and the heat dissipation ability of the control unit based on the power consumption of the control unit and the heat dissipation ability of the control unit that were predicted by predictor 21 and the safety criteria parameter of the control unit stored in storage 31 (S13).

If determiner: 22 determines to optimize the power consumption of the control unit and the heat dissipation ability of the control unit (YES in S13), controller 23 optimizes the power consumption of the control unit and the heat dissipation ability of the control unit (S14). Specifically, controller 23 optimizes the power consumption of the control unit and the heat dissipation ability of the control unit by controlling the driving force (fan speed) of a cooling fan, controlling the driving force (fan speed) of a cooling fan of a radiator included in a water cooler, adjusting the driving force (rotational speed) of a water pump, or controlling the amount of electric current supplied to a peltier element.

Next, controller 23 feeds back, to the acquirer, the power consumption of the control unit and the heat dissipation ability of the control unit when optimized (S16). Then, vehicle thermal management device 1 returns the processing to step S11.

On the other hand, if determiner 22 determines not to optimize the power consumption of the control unit and the heat dissipation ability of the control unit (NO in S13), controller 23 maintains the power consumption of the control unit and the heat dissipation ability of the control unit at the current levels (S15).

Next, controller 23 feeds back, to the acquirer, the power consumption of the control unit and the heat dissipation ability of the control unit when maintained at the current levels (S16). Then, vehicle thermal management device 1 returns the processing to step S11.

### <Actions and Advantageous Effects>

Next, actions and advantageous effects of vehicle thermal management device 1, the vehicle thermal management method, and the program according to the present embodiment will be described.

However, the conventional technique disclosed in PTL 1 gives no consideration to heat dissipation control for satisfying a safety requirement for a control unit provided in the vehicle. Also, a control unit mounted on a vehicle is required to have a highly safe design, and thus highly accurate thermal prediction is required to be performed on the control unit. However, with the conventional technique disclosed in PTL 1, consideration is given only to mapping data and the like, and no consideration is given to highly real-time information such as the status of mobile objects including pedestrians, other vehicles, and the like. Accordingly, the conventional technique disclosed in PTL 1 is problematic in that highly accurate thermal prediction is not performed on the control unit.

In view of this, as described above, vehicle thermal management device 1 according to technique 1 of the present embodiment includes: an acquirer that acquires vehicle information regarding a vehicle and surroundings information regarding surroundings of the vehicle; predictor 21 that predicts, based on at least one of the vehicle information or the surroundings information that are acquired by the acquirer, a power consumption of a control unit and a heat dissipation ability of the control unit that is provided in the vehicle; determiner 22 that determines, based on the power consumption of the control unit and the heat dissipation ability of the control unit predicted by predictor 21 and a safety criteria parameter of the control unit, whether to optimize the power consumption of the control unit and the heat dissipation ability of the control unit, and outputs a result of determination made by the determiner; and controller 23 that controls the power consumption of the control unit and the heat dissipation ability of the control unit according to the result of determination made by determiner 22.

With this configuration, determiner 22 can determine whether to optimize the power consumption of the control unit and the heat dissipation ability of the control unit based on the predicted power consumption of the control unit and the predicted heat dissipation ability of the control unit and the safety criteria parameter of the control unit. If determiner 22 determines that optimization is necessary, controller 23 can perform control to optimize the power consumption of the control unit and the heat dissipation ability of the control unit. Accordingly, it is possible to suppress a situation in which the heat dissipation ability of the control unit is excessively increased while suppressing a situation in which the control unit provided in the vehicle is heated to a high temperature.

If determiner 22 determines that optimization is unnecessary, controller 23 does not have to perform unnecessary control operations.

As described above, it is possible to suppress a situation in which thermal control is performed excessively even though satisfying the safety criteria parameter of the control unit has been satisfied, or a situation in which thermal control is performed insufficiently even though exceeding the safety criteria parameter of the control unit.

Accordingly, with vehicle thermal management device 1, it is possible to perform highly accurate thermal control on the control unit to satisfy the safety requirement for the control unit. As a result, an improvement in the safety of the control unit and suppression of a reduction in the energy efficiency of the entire vehicle can be expected.

Also, vehicle thermal management device 1 according to technique 2 of the present embodiment is vehicle thermal management device 1 according to technique 1. In this case, the vehicle information includes information regarding the control unit provided in the vehicle and cabin sensor information regarding an interior of a cabin of the vehicle. The surroundings information includes: environment information that indicates a weather and a climate of a region in which the vehicle is present; vehicle driving environment information that indicates a surrounding environment in which the vehicle is traveling; and environment temperature information that indicates a temperature of the surroundings of the vehicle.

With this configuration, predictor 21 can more accurately predict the power consumption of the control unit and the heat dissipation ability of the control unit.

Also, vehicle thermal management device 1 according to technique 3 of the present embodiment is vehicle thermal management device 1 according to technique 1 or 2. In this case, determiner 22 determines, using a data table, whether to optimize the power consumption of the control unit and the heat dissipation ability of the control unit, the data table showing a correlation between (i) the power consumption of the control unit and the heat dissipation ability of the control unit predicted by predictor 21 and (ii) the safety criteria parameter of the control unit.

With this configuration, by using the data table, determiner 22 can easily determine whether to optimize the power consumption of the control unit and the heat dissipation ability of the control unit.

Also, vehicle thermal management device 1 according to technique 4 of the present embodiment is vehicle thermal management device 1 according to technique 1 or 2. In this case, determiner 22 determines, using a learning model, whether to optimize the power consumption of the control unit and the heat dissipation ability of the control unit, the learning model having been trained to be able to determine whether to optimize the power consumption of the control unit and the heat dissipation ability of the control unit predicted by predictor 21.

With this configuration, by using the learning model, determiner 22 can easily determine whether to optimize the power consumption of the control unit and the heat dissipation ability of the control unit. Also, by using the learning model, the learning model can be trained for each vehicle, and thus determiner 22 can more accurately determine whether to optimize the power consumption of the control unit and the heat dissipation ability of the control unit according to the vehicle. For this reason, it is possible to perform more highly accurate thermal control on the control unit to further satisfy the safety requirement for the control unit.

Also, vehicle thermal management device 1 according to technique 5 of the present embodiment is vehicle thermal management device 1 according to any one of techniques 1 to 4. In this case, when determiner 22 determines to optimize the power consumption of the control unit and the heat dissipation ability of the control unit, controller 23 optimizes the power consumption of the control unit and the heat dissipation ability of the control unit, and when determiner 22 determines not to optimize the power consumption of the control unit and the heat dissipation ability of the control unit, controller 23 maintains the power consumption of the control unit and the heat dissipation ability of the control unit at current levels.

With this configuration, unless optimization is necessary, controller 23 does not have to perform excessive control. Accordingly, it is unnecessary to excessively suppress the power consumption of the control unit and the heat dissipation ability of the control unit, and thus suppression of a reduction in the energy efficiency of the entire vehicle can be expected.

Also, vehicle thermal management device 1 according to technique 6 of the present embodiment is vehicle thermal management device 1 according to technique 5. In this case, controller 23 feeds back, to the acquirer, the power consumption of the control unit and the heat dissipation ability of the control unit when optimized and the power consumption of the control unit and the heat dissipation ability of the control unit when maintained at the current levels, and predictor 21 predicts the power consumption of the control unit and the heat dissipation ability of the control unit by further taking into consideration the power consumption of the control unit and the heat dissipation ability of the control unit when maintained at the current levels, which have been fed back.

With this configuration, predictor 21 can more accurately predict the power consumption of the control unit and the heat dissipation ability of the control unit. As a result, determiner 22 can more accurately determine whether to optimize the power consumption of the control unit and the heat dissipation ability of the control unit.

Also, vehicle thermal management device 1 according to technique 7 of the present embodiment is vehicle thermal management device 1 according to any one of techniques 1 to 6. In this case, the safety criteria parameter includes a junction temperature, a maximum surrounding temperature, an overheating protection reference value, and a maximum heat transfer amount of the control unit.

With this configuration, whether to optimize the power consumption of the control unit and the heat dissipation ability of the control unit can be determined by taking into consideration the safety criteria parameter of the control unit, and thus the safety of the control unit can be further enhanced.

Also, a vehicle thermal management method according to technique 8 of the present embodiment includes: acquiring vehicle information regarding a vehicle and surroundings information that indicates surroundings of the vehicle, the acquiring being performed by an acquirer; predicting, based on at least one of the vehicle information or the surroundings information that are acquired by the acquirer, a power consumption of a control unit and a heat dissipation ability of the control unit that is provided in the vehicle, the predicting being performed by predictor 21; determining, based on the power consumption of the control unit and the heat dissipation ability of the control unit predicted by predictor 21 and a safety criteria parameter of the control unit, whether to optimize the power consumption of the control unit and the heat dissipation ability of the control unit, and outputs a result of determination, the determining being performed by determiner 22; and controlling the power consumption of the control unit and the heat dissipation ability of the control unit according to the result of determination made by determiner 22, the controlling being performed by controller 23.

With this vehicle thermal management method as well, the same actions and advantageous effects as those described above can be obtained.

Also, a program according to technique 9 of the present embodiment is a program for causing a computer to execute the vehicle thermal management method according to technique 8.

With this program as well, the same actions and advantageous effects as those described above can be obtained.

### (Others)

Up to here, the vehicle thermal management device and the like according to one or more aspects of the present disclosure have been described above by way of an embodiment, but the present disclosure is not limited to the embodiment given above. Other embodiments obtained by making various modifications that can be conceived by a person having ordinary skill in the art to the above-described embodiment without departing from the scope of the present disclosure may also be included within the scope of the one or more aspects of the present disclosure.

For example, in the vehicle thermal management device and the like described above, all or some of the structural elements such as processors may be implemented using dedicated hardware or may be implemented by executing a software program suitable for the structural elements. The structural elements may be implemented by a program executor such as a central processing unit (CPU) or a processor reading and executing a software program recorded in a recording medium such as a hard disk drive (HDD) or a semiconductor memory.

Also, the functional blocks shown in the block diagrams are merely examples. Accordingly, it is possible to implement a plurality of functional blocks as a single functional block, or divide a single functional block into a plurality of blocks. Alternatively, some functions may be transferred to other functional blocks. Also, the functions of a plurality of functional blocks that have similar functions may be processed by a single piece of hardware or software in parallel or by time division.

Also, the order of steps performed in each of the flowcharts is merely an example to specifically describe the present disclosure. Accordingly, the order of steps in each of the flowcharts may be different from those described above. Also, some of the steps may be performed simultaneously (in parallel) with the other steps.

The present disclosure also encompasses other embodiments obtained by making various modifications that can be conceived by a person having ordinary skill in the art to the above-described embodiment as well as embodiments implemented by any combination of the structural elements and the functions of the above-described embodiment without departing from the scope of the present disclosure.

### Further Information about Technical Background to this Application

The disclosure of the following patent application including specification, drawings, and claims is incorporated herein by reference in their entirety: Japanese Patent Application No. 2024-055865 filed on Mar. 29, 2024.

### INDUSTRIAL APPLICABILITY

The vehicle thermal management device and the like according to the present disclosure can be mounted on a vehicle.

1. A vehicle thermal management device comprising:
an acquirer that acquires vehicle information regarding a vehicle and surroundings information regarding surroundings of the vehicle;
a predictor that predicts, based on at least one of the vehicle information or the surroundings information that are acquired by the acquirer, a power consumption of a control unit and a heat dissipation ability of the control unit that is provided in the vehicle;
a determiner that determines, based on the power consumption of the control unit and the heat dissipation ability of the control unit predicted by the predictor and a safety criteria parameter of the control unit, whether to optimize the power consumption of the control unit and the heat dissipation ability of the control unit, and outputs a result of determination made by the determiner; and
a controller that controls the power consumption of the control unit and the heat dissipation ability of the control unit according to the result of determination made by the determiner.

2. The vehicle thermal management device according to claim 1, wherein
the vehicle information includes information regarding the control unit provided in the vehicle and cabin sensor information regarding an interior of a cabin of the vehicle, and
the surroundings information includes: environment information that indicates a weather and a climate of a region in which the vehicle is present; vehicle driving environment information that indicates a surrounding environment in which the vehicle is traveling; and environment temperature information that indicates a temperature of the surroundings of the vehicle.

3. The vehicle thermal management device according to claim 1, wherein
the determiner determines, using a data table, whether to optimize the power consumption of the control unit and the heat dissipation ability of the control unit, the data table showing a correlation between (i) the power consumption of the control unit and the heat dissipation ability of the control unit predicted by the predictor and (ii) the safety criteria parameter of the control unit.

4. The vehicle thermal management device according to claim 1, wherein
the determiner determines, using a learning model, whether to optimize the power consumption of the control unit and the heat dissipation ability of the control unit, the learning model having been trained to be able to determine whether to optimize the power consumption of the control unit and the heat dissipation ability of the control unit predicted by the predictor.

5. The vehicle thermal management device according to claim 1, wherein,
when the determiner determines to optimize the power consumption of the control unit and the heat dissipation ability of the control unit, the controller optimizes the power consumption of the control unit and the heat dissipation ability of the control unit, and when the determiner determines not to optimize the power consumption of the control unit and the heat dissipation ability of the control unit, the controller maintains the power consumption of the control unit and the heat dissipation ability of the control unit at current levels.

6. The vehicle thermal management device according to claim 5, wherein
the controller feeds back, to the acquirer, the power consumption of the control unit and the heat dissipation ability of the control unit when optimized and the power consumption of the control unit and the heat dissipation ability of the control unit when maintained at the current levels, and
the predictor predicts the power consumption of the control unit and the heat dissipation ability of the control unit by further taking into consideration the power consumption of the control unit and the heat dissipation ability of the control unit when maintained at the current levels, which have been fed back.

7. The vehicle thermal management device according to claim 1, wherein
the safety criteria parameter includes a junction temperature, a maximum surrounding temperature, an overheating protection reference value, and a maximum heat transfer amount of the control unit.

8. A vehicle thermal management method comprising:
acquiring vehicle information regarding a vehicle and surroundings information that indicates surroundings of the vehicle, the acquiring being performed by an acquirer;
predicting, based on at least one of the vehicle information or the surroundings information that are acquired by the acquirer, a power consumption of a control unit and a heat dissipation ability of the control unit that is provided in the vehicle, the predicting being performed by a predictor;
determining, based on the power consumption of the control unit and the heat dissipation ability of the control unit predicted by the predictor and a safety criteria parameter of the control unit, whether to optimize the power consumption of the control unit and the heat dissipation ability of the control unit, and outputs a result of determination, the determining being performed by a determiner; and
controlling the power consumption of the control unit and the heat dissipation ability of the control unit according to the result of determination made by the determiner, the controlling being performed by a controller.

9. A non-transitory computer-readable recording medium having recorded thereon a program for causing a computer to execute the vehicle thermal management method according to claim 8.
